(19) United States
(12) Patent Application Publication
(10) Pub. No.: US 2005/0279231 A1
(43) Pub. Date: Dec. 22, 2005

(54) Embossing stylus

(76) Inventor: Chung Heng Lee, Jong Her City (TW)

Correspondence Address: SOFER & HAROUN LLP., 317 MADISON AVENUE, SUITE 910, NEW YORK, NY, 10017, US

(21) Appl. No.: 10/913,286

(22) Filed: Aug. 5, 2004

Related U.S. Application Data
(63) Continuation-in-part of application No. 10/872,135, filed on Jun. 17, 2004.

(51) Int. Cl. B31F 1/07

(52) U.S. Cl. 101/3.1

(57) ABSTRACT

The present invention is for an embossing stylus for embossing a design. The stylus has a central body portion, a removable embossing tip, having at least one embossing point and a spring biasing mechanism. The spring biasing mechanism is disposed on one end of the central body portion, and is configured to contact the removable embossing tip, biasing the embossing point in an outward direction away from the central body portion, such that the embossing point can be used to emboss the desired design.

### RELATED APPLICATION

This application is a continuation-in-part of, and claims the benefit of priority from, U.S. patent application Ser. No. 10/872,135, filed on Jun. 17, 2004, the entirety of which is incorporated herein by reference.

### FIELD OF THE INVENTION

The present invention is directed to an embossing stylus. In particular the present invention is directed to an embossing stylus with an interchangeable, spring biased embossing tip.

### BACKGROUND OF THE INVENTION

In the field of arts and crafts, embossing is one of a number of typical techniques used to adorn paper products with various designs. In addition to standard embossing techniques using prefabricated complimentary embossing designs and receiving plates, the use of embossing styluses is found to be more desirous, allowing the artisan to complete a wider range of embossed designs using a singe apparatus.

To this end, a typical embossing stylus, such as those shown in FIG. 1, are configured to be used in conjunction with an embossing design plate. In operation a user places the sheet medium or craft paper over the embossing sheet and then presses the embossing point of the stylus against the paper at some point within the design on the embossing plate. The user then moves the embossing point along the design, embossing the corresponding design into the sheet medium by deformation.

Although this allows the design on embossing plate to be placed anywhere on a craft paper and also allows a single stylus tool to be used with a number of embossing plates, there are several drawbacks to the prior art designs.

The first drawback to such a system is that the embossing point on the stylus is typically fixed in its position. Thus, when embossing, careful attention has to be paid to the pressure being applied by the user, or else they may apply too much pressure, and consequently breaking the sheet medium and ruining the design.

In order to overcome this drawback, certain prior art styluses, such as the one pictured in FIG. 2, employs a system whereby the stylus point or ball is supported on the inside of the device by a spring mechanism. This allows the user more flexibility when performing the embossing before the pressure threshold of the sheet medium is reached.

However, this arrangement, also suffers from certain drawbacks in that the inclusion of the spring mechanism on the back side of the embossing point results in the point being non-removable. Thus, a maximum of two embossing points can be placed on single device as shown.

When performing a number of embossing designs, differently sized points are often needed to accommodate the various designs on the embossing design plate. In order to have more than two options for embossing points, a user would require at least two separate embossing styluses.

Therefore, it is desirous that an embossing stylus both exhibit the spring supported embossing points in order to maintain the pressure advantages while simultaneously supporting a multiple embossing points such that a user can use a single embossing stylus to perform all of the craft embossing needs.

### OBJECT AND SUMMARY OF THE INVENTION

Therefore it is one object of the present invention to provide an embossing stylus where the embossing point is spring biased within the stylus to allow more control on the pressure of the embossing.

It is another object of the present invention to provide an embossing stylus that maintains a significant number of embossing points, all of which can be used in the spring biased arrangement such that a single stylus can maintain all of the necessary embossing point sizes.

To this end the present invention is directed to an embossing stylus for embossing a design comprised of a central body portion, a removable embossing tip, having at least one embossing point thereon, and a spring biasing mechanism, disposed on at least one end of the central body portion. The spring biasing mechanism is configured to contact the embossing tip, biasing the embossing point thereon in an outward direction away from the central body portion, where the embossing point is configured to emboss a desired design.

### BRIEF DESCRIPTION OF THE DRAWINGS

The objects and advantages of the improved embossing stylus of the present invention will be readily apparent from the reading of the following detailed description of the device constructed in accordance with the invention by reference to the accompanying drawings thereof wherein:

FIG. 1 illustrates prior art embossing styluses;

FIG. 2 illustrates a prior art embossing stylus;

FIG. 3 is a cross sectional side view of an embossing stylus, in accordance with one embodiment of the present invention;

FIG. 4 is a side view of the removed embossing tip for the embossing stylus from FIG. 3, in accordance with one embodiment of the present invention;

FIG. 5 is an exploded view of the embossing tip, and retaining cap for the embossing stylus of FIG. 3, in accordance with one embodiment of the present invention;

FIG. 6 is a side cross sectional view of the embossing tip and spring biasing mechanism of the embossing stylus of FIG. 3 in the outward position, in accordance with one embodiment of the present invention;

FIG. 7 is a side cross sectional view of the embossing tip and spring biasing mechanism of the embossing stylus of FIG. 3 in the inward depressed position, in accordance with one embodiment of the present invention;

FIG. 8 illustrates the embossing stylus of FIG. 3 in use with an embossing plate and sheet media, in accordance with one embodiment of the present invention; and

FIG. 9 illustrates a close up view of the interaction of the embossing tip of the embossing stylus of FIG. 3, with the embossing plate and sheet media, in accordance with one embodiment of the present invention.

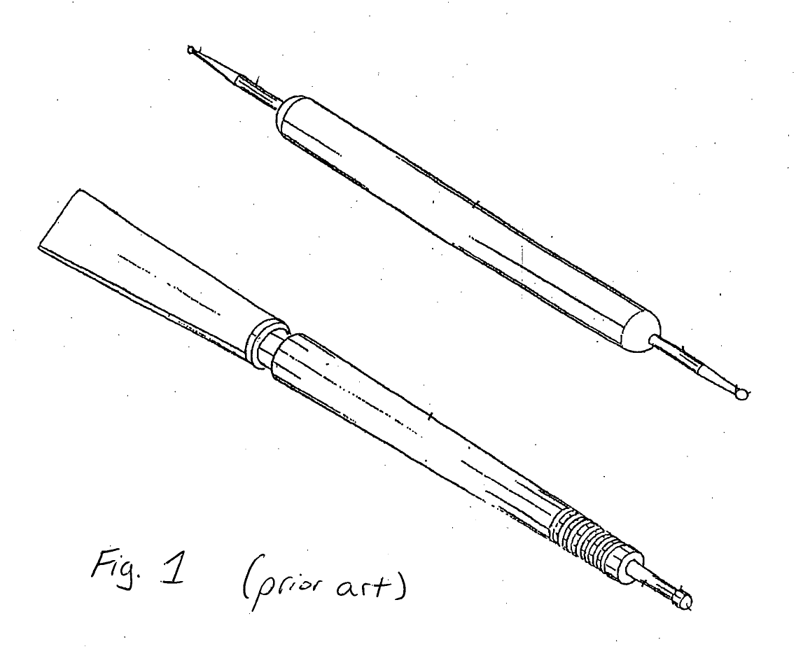

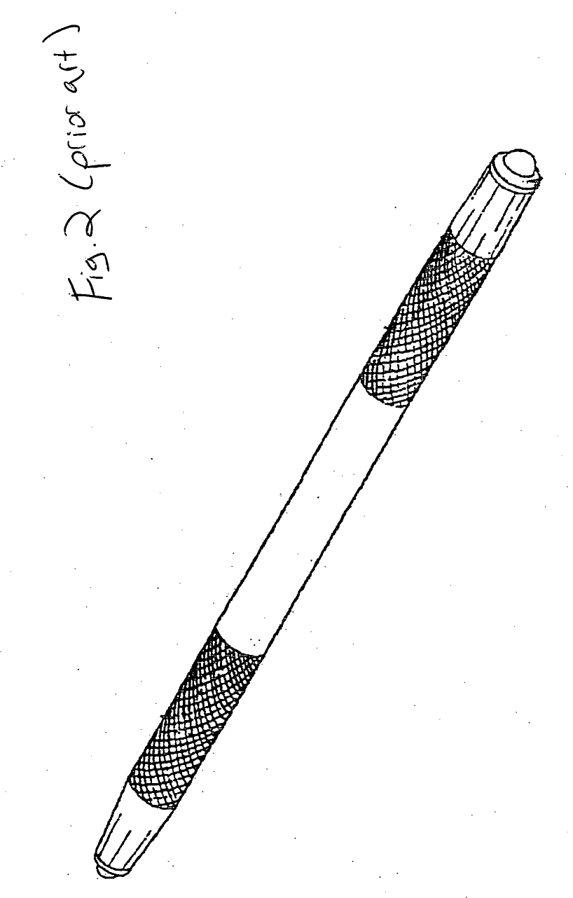

### DETAILED DESCRIPTION OF THE PREFERRED EMBODIMENT

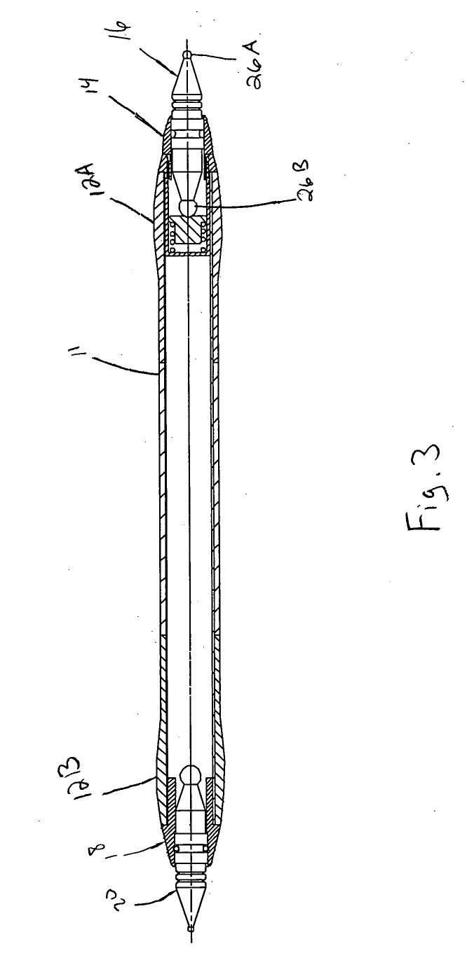

Referring now to the drawings wherein like references characters represent like and corresponding parts throughout the several view, there is illustrated in FIG. 3 an improved embossing stylus 10 embodying the present invention. As illustrated, embossing stylus 10 is comprised of a central body portion 11 and grip portions 12A and 12B.

At a first end, near grip portion 12A, a removable threaded retaining cap 14 is provided, having a first removable embossing tip 16 protruding therefrom. At the second end, near grip portion 12B, is a fixed cap 18, with a second embossing tip 20 also protruding therefrom.

As illustrated in FIG. 4 a close up view of removable embossing tip 16 is shown. Embossing tip 16 is formed from a thickened central shaft 22, configured to be supported within either removable retaining cap 14 or fixed cap 18. A central rubber ring 24 is disposed around the circumference of central shaft 22 to prevent unwanted sliding of embossing tip 16. On either side of central shaft 22, are disposed first and second embossing points 26A and 26B, each of different sizes.

It is understood that second embossing tip 20 maintains all of the same features as first embossing tip 16 except that the sizes of first embossing points 26A and 26B are different in size to that on first embossing tip 16, such that at least four separate size embossing points 26 are provided to accompany a single embossing stylus 10. Furthermore, additional embossing tips beyond tips 16 and 20 may also be provided with the device providing even more possible sizes and shapes for embossing tips 26, even though only two embossing tips can be held in stylus 10 at any one given time.

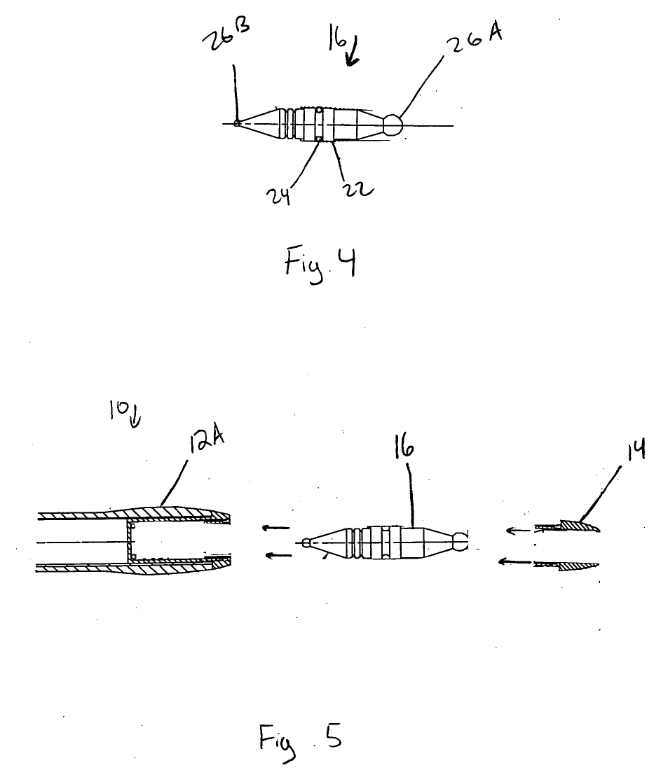

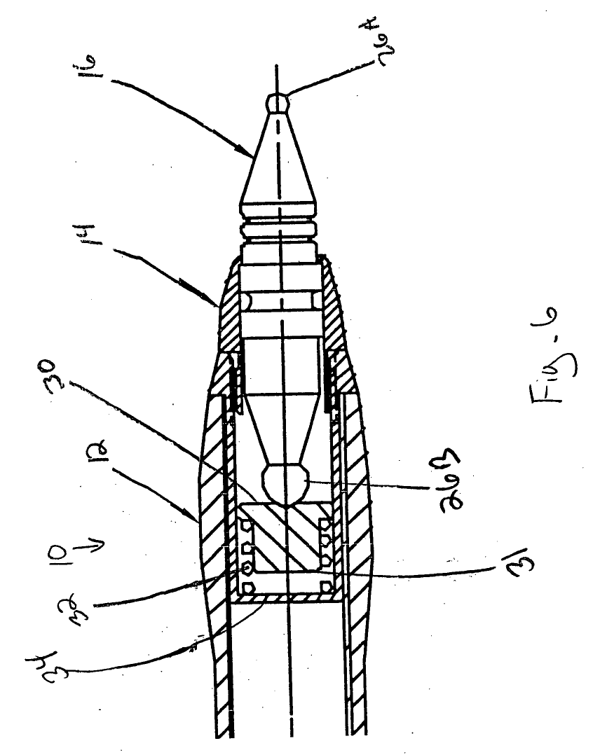

In one embodiment of the present invention, as illustrated in FIG. 5, an exploded view of the first end of stylus 10, near grip portion 12A, shows embossing tip 16, in position to be inserted within an open end of stylus 10. After being placed within stylus 10, removable threaded retaining cap 14 is placed over embossing tip 16 and screwed into a corresponding threading in the open end of stylus 10, wherein the edge of retaining cap 14 contacts central shaft 22, resulting in the fully constructed stylus illustrated in FIG. 3.

It is noted that for the purposes of illustration embossing tip 16 and threaded removable retaining cap 14 are shown in the arrangement illustrated in FIG. 5 on only one end of stylus 10. On the other side of embossing stylus 10, near grip portion 12B second embossing tip 20 is held in place by a non-removable fixed cap 18. Non-removable fixed cap 18 extends downward into the body of stylus 10 and is secures embossing tip 20 by frictionally engaging its central rubber ring 24.

It is understood that this arrangement does not limit the scope of the present invention. For example, it is possible the both sides of stylus 10 can utilize a threaded removable cap 14. However, for the purposes of illustrating the salient features of the spring biasing mechanism for removable embossing tip 16, located on the end having removable retaining cap 14, discussed in detail below, the example stylus 10 will maintain a single removable cap 14 on the end of stylus 10 near first grip portion 12A.

As illustrated in FIG. 6, a cross-section of embossing stylus 10 on the side of grip portion 12A, illustrates the internal spring biasing apparatus. To this end, embossing tip 16 is shown with its partially exposed portion extending out of stylus 10 such that embossing point 26A is available for embossing a design as desired. As illustrated, embossing tip 16 also extends into the open end of stylus 10, such that embossing point 26B is contacted against a spring biasing plate 30.

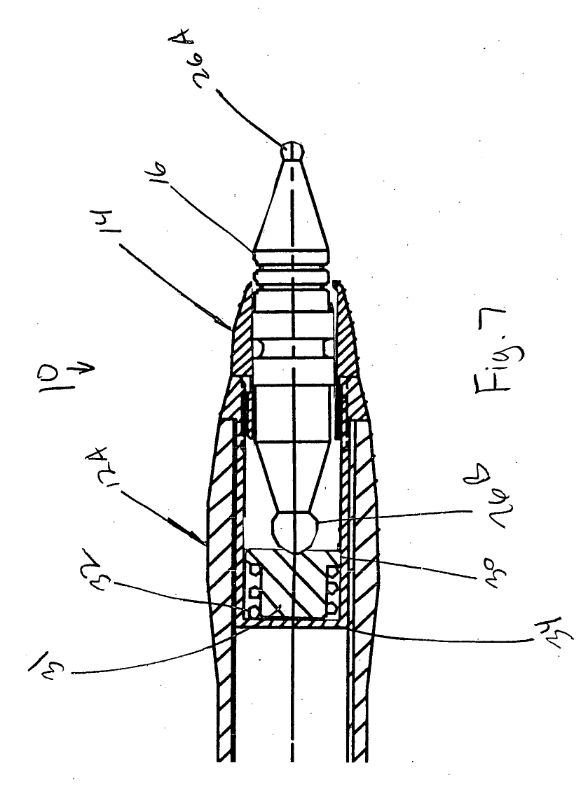

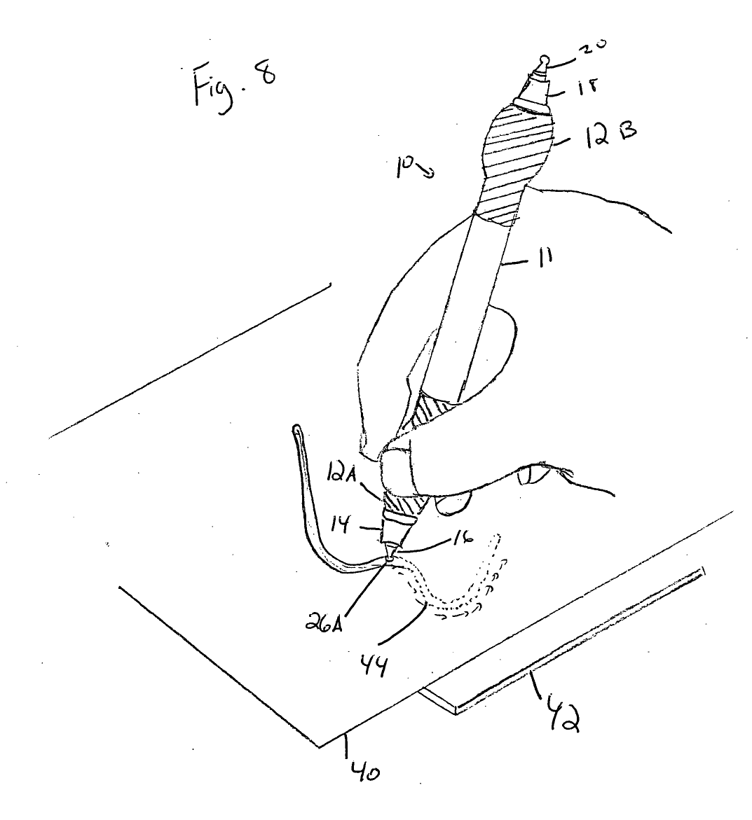

In one embodiment of the present invention, illustrated in FIGS. 6 and 7, spring biasing plate 30, is substantially the same diameter as the inside of stylus 10 and is supported on a spring plate mount 31, of slightly lesser diameter, which extends back into stylus 10. Behind spring biasing plate 30, and around spring plate mount 31, is a spring device 32 which contacts the portion of the underside of biasing plate 30 which extends beyond the diameter of spring plate mount 31.

In the starting position, as illustrated in FIG. 6, spring device 32 presses outwardly against spring plate 30, contacting embossing point 26B of embossing tip 16 and biases embossing point 26A into an extended outward position, where it is held in place at its extension limit by threaded retaining cap 14, by engagement central shaft 22 of embossing tip 16. In such an arrangement the embossing stylus 10 is prepared for use in embossing a desired design into a sheet media such as sheet of craft paper.

In an engaged position, as illustrated in FIG. 7, once a user is in the process of embossing a design, pressure is placed on embossing point 26A of embossing tip 16. The force applied by the user translates through embossing tip 16 to embossing point 26B on the inside of embossing stylus 10 forcing biasing plate 30 and spring device 32 to depress, allowing embossing tip 26A to move inward, relative to the end of stylus 10, rather than breaking the embossed surface of the sheet media. In such an arrangement, embossing tip 16 is allowed to move back and forth, between an outward position against the threaded removable retaining cap 14 and an inward position where spring plate mount 31 abuts a spring plate stopper 34 within stylus 10, thereby absorbing some of the pressure during the embossing.

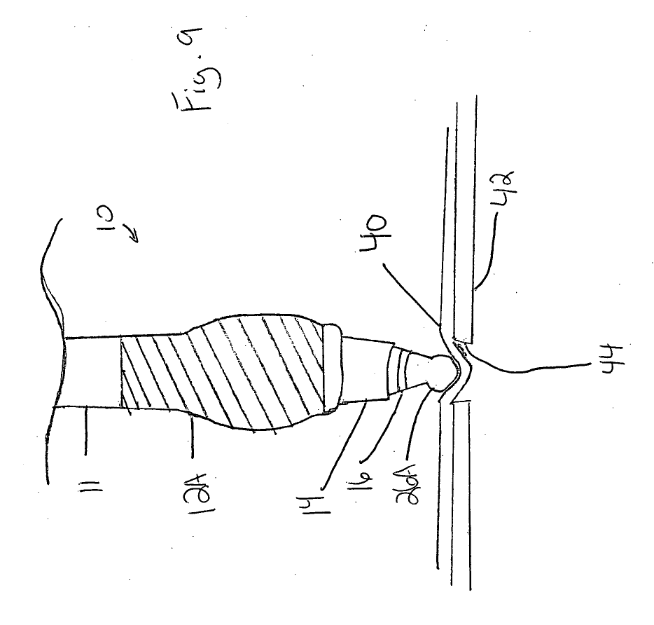

When in use as illustrated in FIG. 8, a sheet media, such as craft paper 40 is placed over an embossing design plate 42. Embossing design plate 42, maintains at least one embossing design 44 on its face, typically in the form of a narrow channel in the shape of the design. After craft paper 40 is placed so that the desired embossing location is disposed over the corresponding design 44, embossing point 26A of stylus 10 is used to emboss the design.

As illustrated in FIG. 8, embossing point 26A of embossing tip 16 depresses an area of craft paper 40 into design 44 of embossing plate 42, resulting in a permanently embossed design. Utilizing embossing stylus 10 as described herein, as the user embosses craft paper 40 along design 44, embossing tip 16 is allowed to absorb some of the pressure, making it less like likely that embossing point 26A will break through craft paper 40.

Further taking advantage of embossing stylus 10 as described herein, as the user changes designs 44 or embossing plates 42, various sized embossing points 26A will be necessary in order to match the width of the embossing design 44, as illustrated in FIG. 8. To this end, as illustrated in FIG. 5, a user can simply remove threaded retaining cap 14, and reverse embossing tip 16 so that embossing point 26B, having a different size than embossing point 26A, extends out from stylus 10. Alternatively, with threaded retaining cap 14 removed, embossing tip 20, being stored in fixed retaining cap 18, can be moved into the spring biasing end of embossing stylus 10 behind removable retaining cap 14, and embossing tip 16 can be stored in non-removable retaining cap 18 near grip portion 12B.

As such an embossing stylus is provided that not only maintains the advantages of having a spring biased embossing points, but also, allows for the interchangeability of the embossing points so that a number of different sized embossing points can utilize the same spring bias mechanism within the context of a single embossing stylus.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

1. An embossing stylus for embossing a design, said embossing stylus comprising:
a central body portion;
a removable embossing tip having at least one embossing point thereon; and
a spring biasing mechanism, disposed on at least one end of said central body portion, configured to contact said removable embossing tip, biasing said embossing point thereon in an outward direction away from said central body portion, wherein said embossing point is configured to emboss the desired design.

2. The stylus as claimed in claim 1, wherein said removable embossing tip maintains a second embossing point, wherein said embossing points are disposed one at either end of said removable embossing tip.

3. The stylus as claimed in claim 2, wherein said embossing points are of different sizes.

4. The stylus as claimed in claim 3, wherein said stylus further comprises a second removable embossing tip, also having two oppositely positioned embossing points, wherein said embossing points on said second removable embossing tip are of different sizes than one another and are both different sizes than those disposed on the first said removable embossing tip.

5. The stylus as claimed in claim 1, wherein said removable embossing tip is held against said spring biasing mechanism by a removable cap retainer.

6. The stylus as claimed in claim 5, wherein said removable cap retainer is removed so that said removable embossing tip can be removed from said stylus.

7. The stylus as claimed in claim 1, wherein said spring biasing mechanism further comprises a bias plate configured to contact said removable embossing tip in order to bias said removable embossing tip in an outward position from said embossing stylus.

8. The stylus as claimed in claim 7, wherein said spring biasing mechanism further comprises a spring device, abutting said basing plate configured to bias said removable embossing tip in an outward position from said embossing stylus.

9. The stylus as claimed in claim 7, wherein said spring biasing mechanism further comprises a spring plate stopper, configured to stops said biasing plate from retracting beyond a certain pre-defined distance within said embossing stylus.

10. An embossing stylus for embossing a design, said embossing stylus comprising:
a central body portion;
a first removable embossing tip, having at least one embossing point thereon;
a second removable embossing tip, having at least one second embossing point thereon;
a first non-removable retainer cap disposed on a first end of said central body portion, for securing said second removable embossing tip to said embossing stylus; and
a spring biasing mechanism, disposed on the second end of said central body portion, configured to contact said first removable embossing tip, biasing said embossing point thereon in an outward direction away from said central body portion, wherein said embossing point is configured to emboss a desired design.

11. The stylus as claimed in claim 10, wherein said first embossing tip maintains a third embossing point and said second embossing tip maintains a fourth embossing point, wherein said first and third embossing points and said second and fourth embossing points are disposed one at either end of said removable embossing tips.

12. The stylus as claimed in claim 1 1, wherein each of said four embossing points are of different sizes.

13. The stylus as claimed in claim 11, wherein said first removable embossing tip is held against said spring biasing mechanism by a removable cap retainer.

14. The stylus as claimed in claim 10, wherein said removable cap retainer is removed so that said first removable embossing tip can be removed from said stylus.

15. The stylus as claimed in claim 10, wherein said spring biasing mechanism further comprises a bias plate configured to contact said first removable embossing tip in order to bias said first removable embossing tip in an outward position from said embossing stylus.

16. The stylus as claimed in claim 15, wherein said spring biasing mechanism further comprises a spring device, abutting said basing plate configured to bias said first removable embossing tip in an outward position from said embossing stylus.

17. The stylus as claimed in claim 15, wherein said spring biasing mechanism further comprises a spring plate stopper, configured to stops said biasing plate from retracting beyond a certain pre-defined distance within said embossing stylus.

18. A method for operating an embossing stylus for embossing a design, where the embossing stylus has a central body portion, said method comprising the steps of:
removing a first embossing tip, having at least one embossing point thereon, from a first non-removable retainer cap disposed on a first end of the central body portion;
removing a second embossing tip, having at least one embossing point thereon, from a spring biasing mechanism, disposed on the second end of said central body portion;
inserting said second embossing tip into said first non-removable retainer cap; and
inserting said first embossing tip into said spring biasing mechanism, wherein said spring biasing mechanism is configured to contact said first removable embossing tip, biasing said embossing point thereon in an outward direction away from the central body portion, wherein said embossing point is configured to emboss a desired design.
